(19) United States
(12) Patent Application Publication
(10) Pub. No.: US 2018/0069454 A1
(43) Pub. Date: Mar. 8, 2018

(54) Perpetutek

(71) Applicants: Oran Wiley Greene, Moorhead, MN (US); Quinton Russell Greene, Moorhead, MN (US); Matthew Oran Greene, Orlando, FL (US); Abigail Noel Greene, Moorhead, MN (US); Donovan Rhys Greene, Plymouth, MN (US); Leah Nicole LaDuke, Moorhead, MN (US); Garrett Taylor Greene, Moorhead, MN (US); George F. Proto, Orlando, FL (US)

(72) Inventors: Oran Wiley Greene, Moorhead, MN (US); Quinton Russell Greene, Moorhead, MN (US); Matthew Oran Greene, Orlando, FL (US); Abigail Noel Greene, Moorhead, MN (US); Donovan Rhys Greene, Plymouth, MN (US); Leah Nicole LaDuke, Moorhead, MN (US); Garrett Taylor Greene, Moorhead, MN (US); George F. Proto, Orlando, FL (US)

(21) Appl. No.: 15/258,972

(22) Filed: Sep. 7, 2016

(51) Int. Cl. H02K 7/18; H02K 7/06; H02K 7/116

(52) U.S. Cl. CPC H02K 7/1861; H02K 7/116; H02K 7/06

(57) ABSTRACT

This invention is a device that captures and stores kinetic energy from repetitive motions to then be released to generate electrical energy that can be stored or used. It does this by using springs, levers, compressors, and other mechanical devices to capture and then slowly release kinetic energy to power generators that convert the kinetic energy to electrical energy.

### BACKGROUND

My wrists were tired from typing while I worked one day and this led me to try to develop a method to convert the kinetic energy from pressing in keys on a keyboard into electric energy used to charge the computer.

In developing this idea further it became apparent that the technology involved could be used in various embodiments comprising ways to capture and convert the kinetic energy of a multitude of repetitive daily motions, some voluntary and some involuntary, into electrical energy.

The following is a description of various embodiments meant to show the multitude of ways in which the device being described may be used to accomplish the task of converting kinetic energy into electrical energy. These descriptions are designed to be a representative sampling of the uses of the technology and will not be exhaustive in nature.

The failure to describe a particular use does not allow for the technology as designed and arranged to be used without permission of the inventor(s) as long as the technology is being used in essentially the same manner and for essentially the same functions

### BRIEF DESCRIPTION OF THE CLAIM AND OF THE SEVERAL VIEWS OF THE DRAWING(S)

Having thus described the invention in general terms, reference will now be made to the accompanying drawings, which are not necessarily drawn to scale, and wherein:

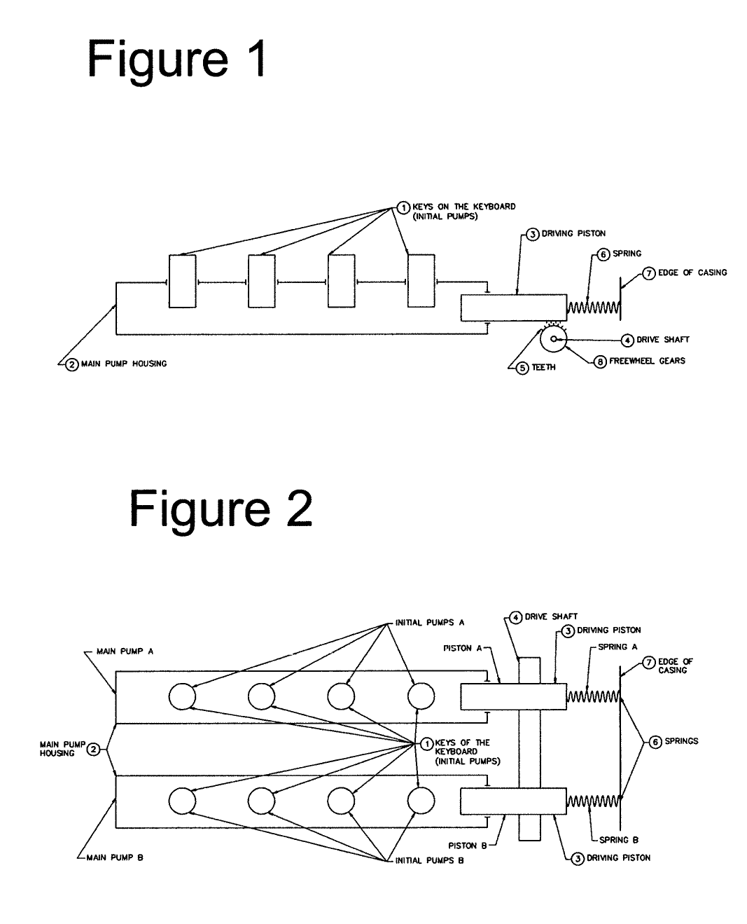

FIG. 1 is an exemplary side view of the chamber and pistons or compressors/pumps used in the hydraulic pressure system which includes the point on which it connects to the main drive shaft.

FIG. 2 is an exemplary above view of 2 chambers and the pistons or compressors/pumps which go with them used in the hydraulic pressure system which includes the points at which both chambers mount to the main drive shaft.

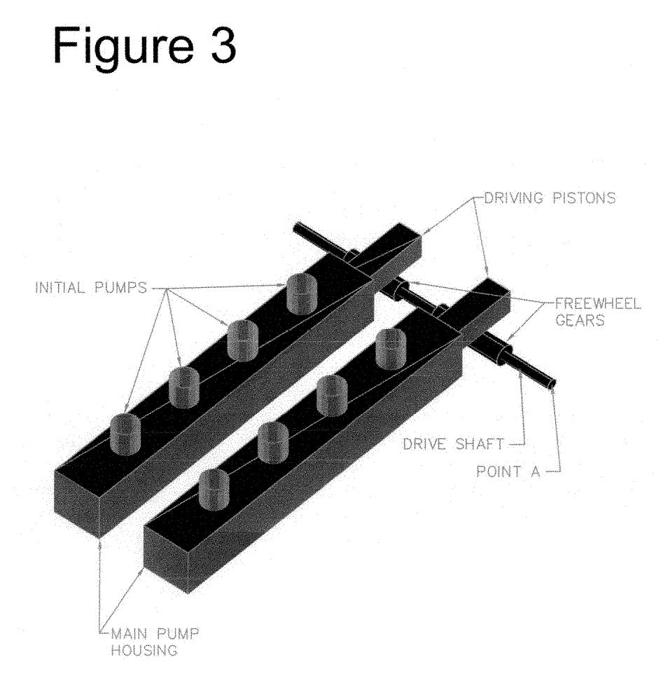

FIG. 3 is an exemplary view of the flow of energy from the kinetic press of the initial hydraulic pumps or compressors to the electrical output from the alternator.

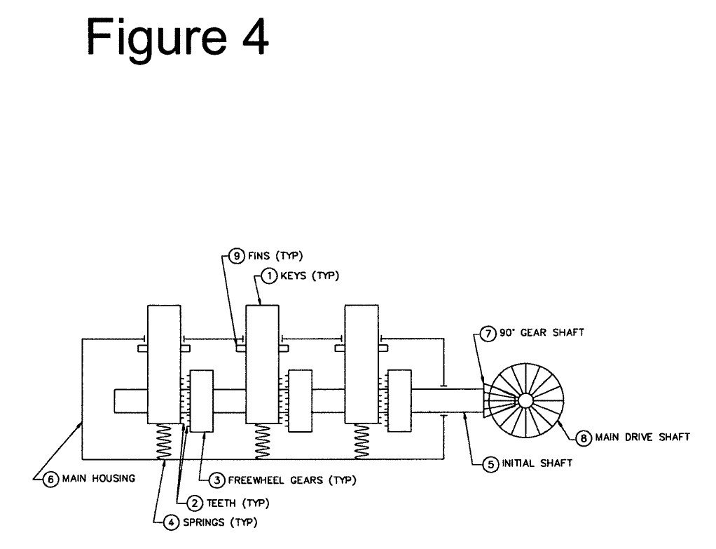

FIG. 4 is an exemplary side view of the mechanical shafts and the main drive shaft used in the mechanical shafts system

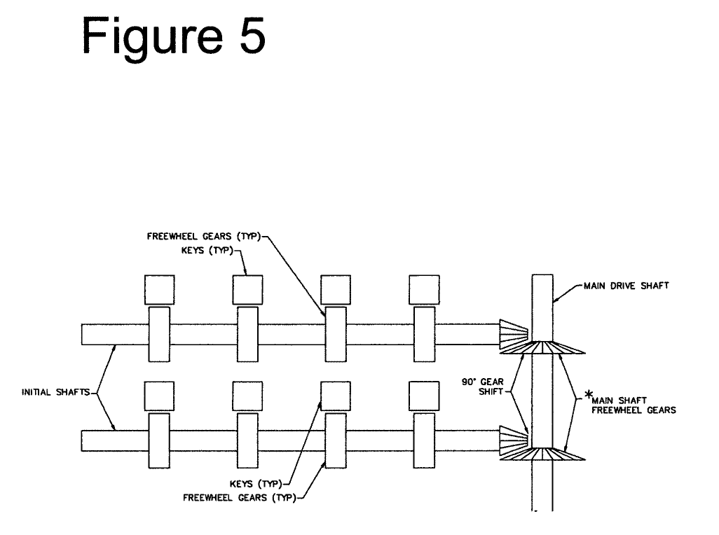

FIG. 5 is an exemplary above view of two initial shafts and pistons used in the mechanical drive shaft system which includes the points at which the initial shafts connect to the main drive shaft and the gearing mechanism used to convert the direction of the rotation.

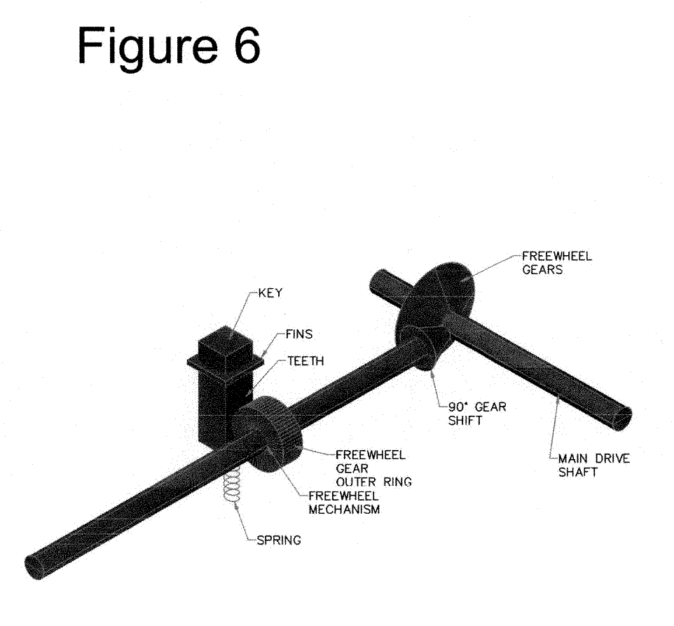

FIG. 6 is an exemplary view from above and to the side of how the keys and initial shaft connect to the main drive shaft as a graphic representation of how the system works in the mechanical shaft system.

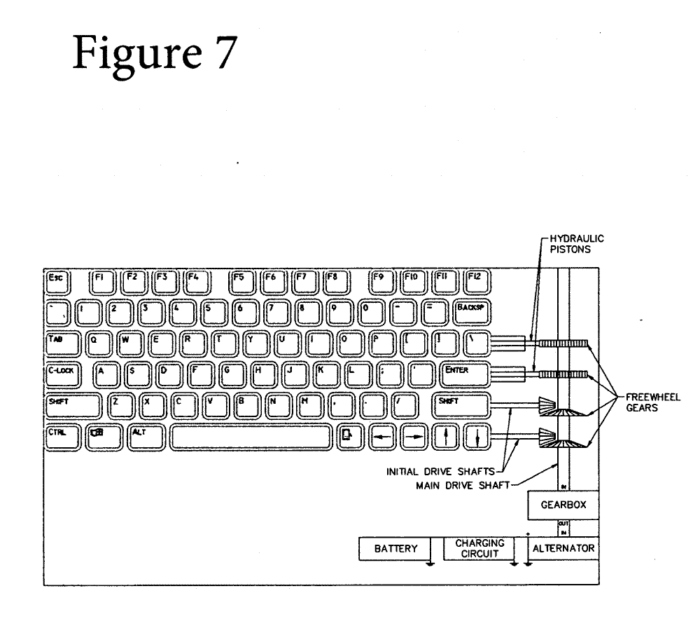

FIG. 7 is a graphic representation of how the energy will flow from the keyboard and eventually end up in the battery

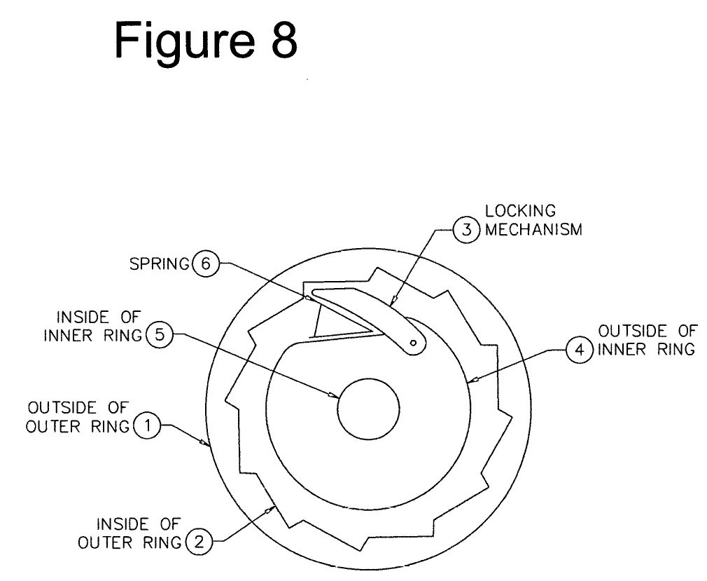

FIG. 8 is a graphic representation of how the freewheel gears mentioned in my project will operate.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Products, Methods, and Entities

Embodiments of the present invention may be implemented in various ways, including as built-in keyboards, stand alone keyboards, mice, touch screen input devices, computing device cases, game controllers, wearable articles, medical devices, construction materials, exercise equipment, etc. all of which are capable of receiving repetitive compressing of the components which will create the mechanical motions that will be transformed into electrical energy.

In one embodiment, the device may be part of a keyboard, included with a desktop or other non-portable computer (irrespective of its operating system), which can be either a peripheral device or as a component of an all-in one computing device. The keyboard, can be a standard qwerty style keyboard or any other keyboard design which is used to input data through the repetitive depressing of any of the keys in the keyboard.

In one embodiment, the device may be part of a laptop computer (irrespective of its operating system). The keyboard, can be a standard qwerty style keyboard or any other keyboard design which is used to input data through the repetitive depressing of any of the keys in the keyboard.

In one embodiment, the device may be part of a stand alone keyboard for use wirelessly or through a connection such as USB (or other similar connection) with computing devices such as, tablets, smart phones, smart watches, etc. (irrespective of their operating systems). The keyboard, can be a standard qwerty style keyboard or any other keyboard design which is used to input data through the repetitive depressing of any of the keys in the keyboard.

In one embodiment, the device may be part of a mouse used for input of data to any number of computing devices, such as, desktop or other non-portable devices, laptops, tablets, etc. (irrespective of their operating systems) to capture the repetitive nature of clicking the buttons on a mouse.

In one embodiment, the device may be part of a touch screen device used for the input of data into a computer, tablet, smart phone, etc. (irrespective of its operating systems) which will capture the repetitive nature of the motions used to operate a touchscreen device and/or a specific button or lever that may be pressed in a repetitive nature.

In one embodiment, the device may be part of a case designed for a computing device which will capture the repetitive nature of the motions used to operate a touchscreen device and/or a specific button or lever that may be pressed in a repetitive nature.

In one embodiment, the device may be part of a game controller (irrespective of its operating systems) to capture the repetitive nature of pressing the controls on the gaming controller.

In one embodiment, the device may be part of a wearable device, such as shoes, watches, etc to capture the natural repetitive motions of the human body.

In one embodiment, the device may be part of a medical device, such as a pacemaker, that could be implanted in the body and the device could be operated by the repetitive motion of the expanding and contracting of muscle or other tissue whether that motion is voluntary or involuntary.

In one embodiment, the device could be embedded in flooring products such as tiles, wood planks, etc. or below such products in a supporting structure to capture the repetitive motion of the flooring material caused by the constant flow of foot traffic on the flooring material.

In one embodiment, the device could be implanted in or connected to the hinges of doors to capture the repetitive motion of the opening and closing of the doors.

In one embodiment, the device could be embedded in road construction material to capture the repetitive motion of the compressing of the material due to regular vehicular traffic over the material.

In one embodiment, the device may be part of exercise equipment such as a treadmill to capture the repetitive motions inherent in exercise regimens.

Embodiments of the present invention are described below with reference to block diagrams and flowchart illustrations. Thus, it should be understood that each block of the block diagrams and flowchart illustrations may be implemented in the form of a keyboard, mouse, touch screen, case, game controller, wearable device, medical devices, construction materials, exercise equipment, etc. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary Components

FIGS. 1-8 provides an illustration of an exemplary embodiment of the present invention. As shown in these figures, this particular embodiment may include one or more user-operated entities/devices, such as a keyboard, a mouse, touch screen, case, game controller, wearable device, and/or the like. The user-operated entities/devices may be connected to one or more computing entities described below.

1. Exemplary Computing and/or Medical Entity

In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles, watches, wristbands, wearable items/devices, items/devices, vehicles, kiosks, input terminals, servers, set-top boxes, base stations, medical devices and the like, and/or any combination of devices or entities adapted to perform the functions, operations, and/or processes described herein. Such functions, operations, and/or processes may include, for example, typing on a keyboard, clicking a mouse, depressing a touch screen device, activating the triggers and keys on a gaming controller and/or similar terms used herein interchangeably. In one embodiment, these functions, operations, and/or processes can be performed to input data, and/or similar terms used herein interchangeably.

In one embodiment, the device may communicate with various computing entities, through multiple ports or wirelessly to provide charging power to each computing entity simultaneously.

As shown in FIGS. 1-3, in one embodiment, the device captures mechanical energy to be transformed into electrical energy from the input action through the use of hydraulic pressure or air pressure created by the input action.

As shown in FIGS. 4-6, in one embodiment, the device captures mechanical energy to be transformed into electrical energy from the input action through the use of gears and shafts (and possibly springs) which move as a result of the input action.

In one embodiment, the device transmits electrical energy to the energy storage device (battery, etc.) through permanent direct electrical connections.

In one embodiment, the device transmits electrical energy to the energy storage device (battery, etc.) through temporary electrical connections via connecting cables that can be attached and removed at will.

In one embodiment, the device transmits electrical energy to the energy storage device (battery, etc.) through wireless transmission of energy.

Although not shown, the computing entity may include or be in communication with one or more input elements, such as a keyboard input, a mouse input, a touch screen/display input, joystick input, gaming controller input, keypad input, and/or the like, each containing an embodiment of the device, providing multiple sources of electrical energy for charging the energy storage device.

### 2. Exemplary Construction and Exercise Entity

In general, the terms construction entity, entity, device, system, and/or similar words used herein interchangeably may refer to, for example, one or more flooring components, doors, substructures, exercise equipment and the like, and/or any combination of devices or entities adapted to perform the functions, operations, and/or processes described herein. Such functions, operations, and/or processes may include, for example, walking on the floor, running/walking on a treadmill, rowing a rowing machine, using a stair-stepper, opening and closing doors. In one embodiment, these functions, operations, and/or processes can be performed to capture kinetic energy, and/or similar terms used herein interchangeably. In one embodiment, the device may communicate with various computing entities, through multiple ports or wirelessly to provide charging power to each computing entity simultaneously.

As shown in FIG. 1-3, in one embodiment, the device captures mechanical energy to be transformed into electrical energy from the input action through the use of hydraulic pressure created by the input action.

As shown in FIGS. 4-6, in one embodiment, the device captures mechanical energy to be transformed into electrical energy from the input action through the use of gears and shafts (and possibly springs) which move as a result of the input action.

In one embodiment, the device transmits electrical energy to the energy storage device (battery, etc.) through permanent direct electrical connections.

In one embodiment, the device transmits electrical energy to the energy storage device (battery, etc.) through temporary electrical connections via connecting cables that can be attached and removed at will.

In one embodiment, the device transmits electrical energy to the energy storage device (battery, etc.) through wireless transmission of energy.

### 3. Exemplary Power Sources/Supplies for Computing and Construction Entities

Upon the generation of the electrical energy a circuit will smooth out the energy produced and store it temporarily in capacitor banks or other temporary power storage component which can then dump the stored energy in a number of ways. Induction coils may be used to wirelessly charge compatible devices nearby. A hardwired connection may be established either permanently or as a removable connection. Signals similar to WiFi may be used for a slightly longer ranged wireless connection. The hard wired connections can include but will not be limited to the following: USB, Charging brick converters, proprietary connections used by tablets, computers and phones currently, etc.

1. A device such as a keyboard, mouse, touch screen, case, gaming controller, wearable devices, medical devices, construction materials, exercise equipment, etc. which harvests kinetic energy used in the typing/clicking/pressing process involving repetitive motions and converts it into electrical energy which is then stored or used by means of batteries, capacitors, or other methods.

2. The device in claim 1, can exist to be built into various devices, or as an independent device connected by means of wireless systems (bluetooth, radio frequencies, WiFi, etc. . . . ) or hard wired into any device compatible with it in a manner which allows the user to disconnect or reconnect the device at will.

3. The device in claim 1, harvests the kinetic energy in methods such as hydraulic pistons, rotating shafts, springs, etc. which in turn will amount to turning a main shaft.

4. The hydraulic pistons in claim 3, can be comprised of multiple initial pistons which depress with the use of the key resting above and can be (but are not required to be) grouped into multiple keys connected to the same hydraulic chamber.

5. The initial pistons in claim 4, will upon depression build pressure in the hydraulic chambers housing forcing the main piston to express outward from the housing and building pressure in springs underneath each initial piston.

6. The main piston in claim 5, will upon expression rotate the main shaft of this system and build pressure in a spring.

7. The main piston in claim 5, will upon initial piston expression, return to it's resting position by the spring in claim 6.

8. The initial pistons in claim 4, upon release will return to their resting position by the springs in claim 5.

9. The rotating shafts in claim 3, can be comprised of a pillar with teeth at the bottom of each key which builds pressure within a spring and turns a gear connected to the initial shaft in this system.

10. The pillar in claim 9, upon key release will return to resting position by the spring in claim 9.

11. The gears in claim 9, can be freewheel gears to reverse rotation upon key expression, and unwanted key depression from keys that were not pressed.

12. The initial shaft in claim 9, can connect with gears at the end which forces the main shaft in claim 3, which rests perpendicular to it, to rotate as well.

13. The gear mentioned in claim 12, on the main shaft in claim 3, will be a freewheel gear to prevent all initial shafts mentioned in claim 9 from rotating in unison when one is forced into rotation.

14. The main shaft in claim 3, will be inserted into a gearbox used to convert relatively low RPM into a high enough value to produce the electricity with the use of an (multiple) alternator(s).

15. The alternator(s) in claim 14, which produce inconsistent voltage will have their voltage values smoothed out by a charging circuit and voltage regulator.

16. The voltage regulator in claim 15, can be used to charge any compatible device or a built in battery pack.
